(19) United States
(12) Patent Application Publication
(10) Pub. No.: US 2017/0327770 A1
(43) Pub. Date: Nov. 16, 2017

(54) METHOD AND SYSTEM FOR WASHING OF CRUDE TALL OIL SOAP

(71) Applicant: Anders Göran HOFSTEDT, Linköping (SE)

(72) Inventor: Anders Göran HOFSTEDT, Linköping (SE)

(21) Appl. No.: 15/533,132

(22) PCT Filed: Dec. 9, 2015
(86) PCT No.: PCT/SE2015/051320

§ 371 Date: Jun. 5, 2017

(30) Foreign Application Priority Data
Dec. 10, 2014 (SE) 1451515-9

(51) Int. Cl. C11B 13/00; C11D 13/30; B04B 5/10; D21C 11/00; B04B 1/08

(52) U.S. Cl. CPC C11B 13/005; D21C 11/0007; B04B 1/08; B04B 5/10; C11D 13/30

(57) ABSTRACT

Method for purifying crude tall oil soap from black liquor, wherein a washing liquid is used, which washing liquid is either pH-regulated residual liquid from a tall oil producing processing step (180) or a pH-regulated aqueous solution of ash, wherein black liquor-containing crude tall oil soap is mixed with said washing liquid, and wherein the crude tall oil soap is then separated out from the resulting mixture. The method comprises the steps 1. performing a first coarse separation (120,130) of crude tall oil soap from said black liquor, so that a first crude tall oil soap fraction is formed; 2. mixing (140) the first crude tall oil soap fraction with washing liquid, so that a first diluted fraction is formed; and 3. performing a separation (150) of the first diluted fraction using a first centrifugal separator of purificator type, so that a second crude tall oil soap fraction is achieved. The second crude tall oil soap fraction comprises smaller contents of black liquor than the first crude tall oil soap fraction. The invention also relates to a system.

The present invention relates to a method and a system for washing of crude tall oil soap.

In pulp production using the Kraft process, crude tall oil soap is produced, which is then available as an admixture in the so-called black liquor. It is desirable to separate the crude tall oil soap, for processing in subsequent processing steps with acid, usually sulfuric acid, to provide tall oil, which is a raw material for many applications.

To achieve good results in the production of tall oil from crude tall oil soap, it is desirable that the input crude tall oil soap is relatively clean, with as low amounts of black liquor as possible, since the black liquor contains dissolved lignin which precipitates when crude tall oil soap, by acidification, is cleaved to tall oil. Additionally, the black liquor contains calcium, in the form of, inter alia, calcium carbonate, and also cellulose fibres. It is therefore desirable that the relatively pure crude tall oil soap contains as low proportions of black liquor as possible. The precipitated lignin produces sludge which is expensive and cumbersome to handle, and calcium contributes to troublesome deposits on the equipment used.

To separate out the black liquor, and as a result lignin and calcium, from crude tall oil soap, it has been proposed, in U.S. Pat. No. 8,419,897 B2, to use the residual liquid from the acid treatment of the crude tall oil soap, the residual liquid first having been treated with sodium hydroxide to form a solution with a pH value of between 10-14. This basic-made residual liquid is mixed with the contaminated crude tall oil soap, after which the soap is separated out from the obtained mixture.

Even if such a method provides better separation of black liquor, and therefore lignin and calcium, as compared to the prior art, it takes long time, requires bulky equipment and provides a soap still containing substantial proportions of black liquor and other impurities, such as precipitated lignin.

The present invention solves these problems.

Hence, the invention relates to a method for purifying crude tall oil soap from black liquor, wherein a washing liquid is used, which washing liquid is either derived from a tall oil producing processing step in which crude tall oil soap is treated with acid to form tall oil, wherein the residual liquid is an acidic residual liquid phase from this processing step that has been pH-regulated, or alternatively that the washing liquid is a pH-regulated aqueous solution of ash, wherein black liquor-containing crude tall oil soap is mixed with said washing liquid, and wherein the crude tall oil soap is then separated out from the resulting mixture, characterised in that the method comprises the steps of a) performing a first coarse separation of crude tall oil soap from said black liquor, so that a first crude tall oil soap fraction is formed; b) mixing the first crude tall oil soap fraction with washing liquid, so that a first diluted fraction is formed; and c) performing a separation of the first diluted fraction using a first centrifugal separator of purificator type, so that a second crude tall oil soap fraction is achieved, whereby the second crude tall oil soap fraction comprises smaller contents of black liquor than the first crude tall oil soap fraction.

Furthermore, the invention relates to a system according to claim 15.

The invention will now be described in detail, with reference to exemplifying embodiments of the invention and to the accompanying drawings, wherein:

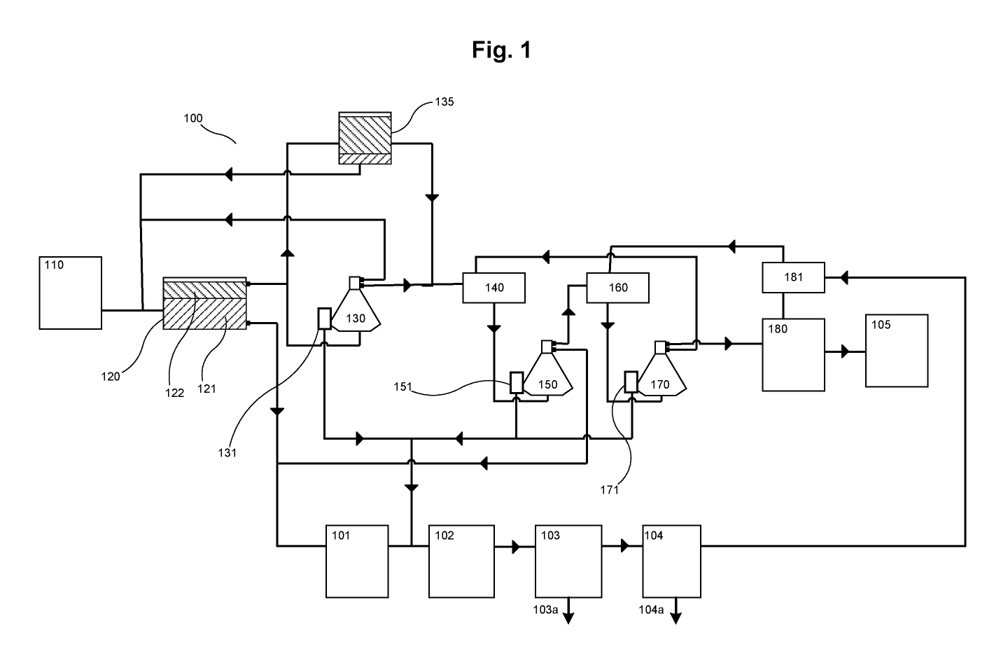

FIG. 1 is a schematic overview of a system according to the present invention for performing a method according to the invention;

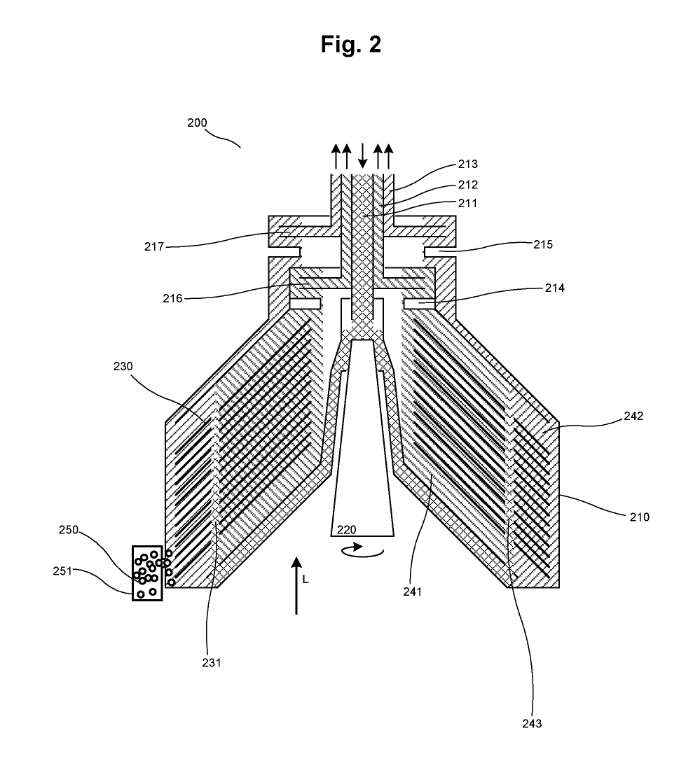

FIG. 2 is a schematic diagram of an open centrifugal separator of purificator type; and

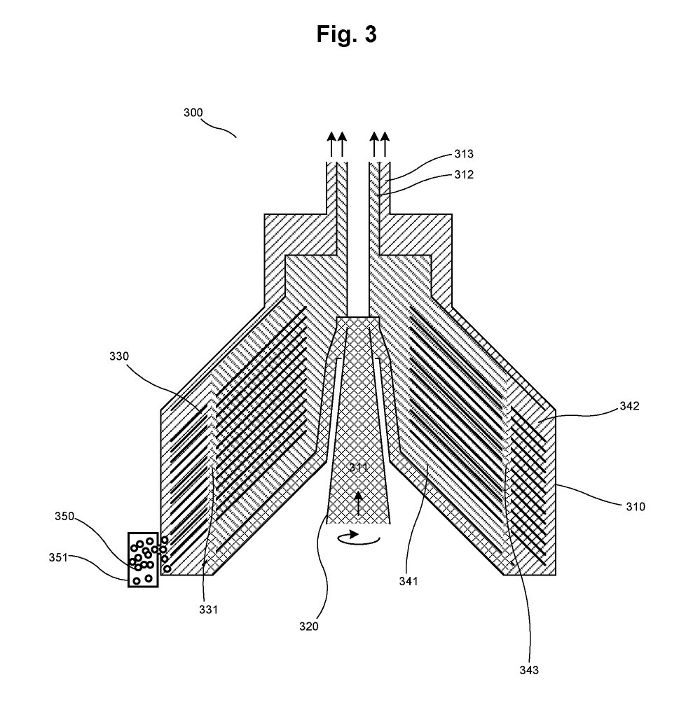

FIG. 3 is a schematic diagram of a hermetic centrifugal separator of purificator type.

FIG. 1 shows a system 100 according to the present invention for use in a method according to the invention. Specifically, the system 100 is useful in a method according to the invention to wash out, or purify (separate out), crude tall oil soap from black liquor, in other words to clean a black liquor containing mixture from crude tall oil soap so that the black liquor contents in the purified crude tall oil soap is decreased as a result of the purification.

Additionally, the system 100 and method according to the invention accomplishes a crude tall oil soap with low levels of other pollutants, such as cellulose fibres and calcium carbonate.

In FIG. 1, 110 denotes a per se conventional cooking step in a pulp fabrication process according to the Kraft process, which step 110 as a residue accomplishes comparatively large volumes of black liquor. This black liquor is supplied to a separation step 120, which preferably, but not necessarily, may be used for the present purposes, and the aim of which is to carry out a first separation of black liquor from the crude tall oil soap. It is preferred that, as shown in FIG. 1, the separation step consists of a gravimetric separation tank in which the crude tall oil soap is allowed to float to the surface, as a result of the density difference relative to the black liquor, so that a relatively concentrated crude tall oil soap fraction 122 is formed, floating on top of a fraction of relatively concentrated black liquor 121. The black liquor fraction 121 is passed to a subsequent processing step, such as a combination of a per se conventional evaporation plant 101 and a subsequent, conventional recovery boiler 102. The exhaust gases from the recovery boiler 102 are supplied to a per se conventional electrostatic precipitator 103, arranged in the flue gas stream from the recovery boiler 102 and arranged to separate out the ash particles from the flue gases in question. The gaseous components of the flue gases leave in stream 103a, and the separated solid and particulate ash is led further to a dissolution device 104, such as a tank, in which the ash particles are dissolved in water to form an aqueous solution of such ash. Non-dissolved material leaves in a stream 104a. The aqueous solution of the ash from the boiler 102 is brought, in one aspect of the invention, to a step 181 (see below).

Thus, the system 100 can, but needs not, comprise the separating step 120. In case the separation step 120 is used, it is preferred that the crude tall oil soap fraction 122 is brought to, and further purified in, an initial centrifugal separating step 130. The step 130 comprises a centrifugal separator arranged to separate the input black liquor-mixed crude tall oil soap to form a separated black liquor fraction which is returned to the step 120; a fraction containing solid material, including fibres and other impurities, which is brought to a subsequent processing step, such as recovery boiler 102; and a crude tall oil soap fraction, which is passed on to step 140 (see below). The solid fraction is removed using an as such conventional ejection device 131 for solid particles, installed as a part of step 130.

FIG. 1 also illustrates a separating step 135, which is alternative to the separating step 130, in the form of a purification line comprised of one or more tanks, which line is also arranged to separate the input black liquor-mixed crude tall oil soap, so that the corresponding fractions are formed as using step 130.

The steps 120 and 130, or 120 and 135, illustrated in FIG. 1, form, in respective combination, a step according to the invention for performing a first coarse separation. According to various embodiments of the invention, the coarse separation step may, but needs not, comprise a gravity tank 120. Such a first coarse separation can thus comprise a separation of a crude tall oil soap fraction by means of a centrifugal separator, or a separation of a crude tall oil soap fraction by gravimetric separation in a tank 120, and a subsequent initial centrifugation step 130, or a removal of a crude tall oil soap fraction by gravimetric separation in successive tanks 120, 135. In the case only gravimetric separation is used, it is preferred to also separate solid sedimented particles contained in the black liquor in this way.

Conventionally, so-called centrifugal separators of high speed type (HSS, “High Speed Separator”) are used for separation, in which a separation bowl rotates, preferably at least at 1000 RPM, such as at least 3000 RPM, more preferably at least 5000 RPM, thereby creating a radially directed centrifugal force acting on the material present inside the bowl. As a result, a relatively lighter phase is squeezed towards the centre of rotation of the bowl, while a relatively heavier phase is pressed outwards against the periphery of the bowl. In order to increase the separation efficiency, stacked conical separating plates are used in the bowl. A separator of this type is described for example in EP2664385 A1.

There are different types of centrifugal separators.

In so-called open separators, the phase mixture is fed in through an inlet, is separated and then delivered at different outlets. One type of such open separator delivers respective phases at the respective outlets at atmospheric pressure, which generally requires external pumps for further removal of the phase in question.

Using so-called paring discs, acting as centripetal pumps, the separated phases are instead delivered at the respective outlets at a certain overpressure. In a separator of this type, such as disclosed for instance in SE534386 C2, the boundary level in the bowl, that is, the horizontal distance from the centre of rotation where the boundary between the separated phases is located, can be adjusted by changing the width of the gravity discs or level discs, hereinafter referred to as level rings. Hence, using such level rings, the radial level of the io heavier phase, which exerts a pressure on the lighter phase towards the centre of rotation, can be adjusted.

In such a separator, the heavier phase is pumped out through a paring disc disposed with its edge radially outside the corresponding paring disc which pumps out the lighter phase. Since the paring discs are fixedly disposed, and thus do not rotate with the bowl, there is a risk of leakage from the heavier phase to the lighter phase, especially if the pressure in the heavier phase is high.

A so-called hermetic separator, or a hermetically closed separator, on the other hand, is designed so that there is no free passage between the two separated phases in the separator. Instead, the output pressure is achieved by the mixture being pumped into the separator at an overpressure, which overpressure is also used to create a counter-pressure by means of so called counter-pressure valves provided on the output phases, which valves regulate the position of the boundary level in the bowl. Such a hermetic separator is described in, for example, 5E0950840 A1. Additional remarkable features of a hermetic separator include that the separator during operation is completely filled with the supplied mixture and the separated phases, and that no air is then present in the separator; and that a pressure which is applied at the inlet propagates to a corresponding pressure at the outlet.

Furthermore, there are different kinds of separators depending on the phase which primarily is to be purified from the other. For this purpose, through-holes are used in the said stack of separating discs at a certain distance from the centre of rotation. This results in the two phases having to go a different radial distance before being collected. For maximum purifi-cation of the light phase, a so-called purificator is used, in which the holes are arranged relatively far from the centre of rotation. For maximum purification of the heavy phase, a so-called concentrator is used, wherein the holes are arranged relatively close to the centre of rotation.

Such a centrifugal separator of concentrator type is illustrated in FIG. 2, in the form of an as such conventional, open centrifugal separator 200, comprising a central inlet 211 for the mixture through which the mixture is introduced into the bowl 210 for separation therein, and an exit via respective outlets 212 for a light phase 241 and 213 for a heavy phase 242. The two phases 241, 242 and the mixture of them are marked using different types of broken lines in FIGS. 2 and 3.

The bowl 210 is rotated, preferably at a rotation speed of at least 1000 RPM, preferably at least 3000 RPM, preferably at least about 5000 RPM, by means of a drive mechanism acting on a shaft 220. A stack of a plurality of separating discs 230 is used to increase the efficiency of the separation, in a per se conventional manner. The light phase 241 is pressed radially inwards, and is pumped out through a stationary arranged centripetal pump 216 (not shown in FIG. 2). Similarly, the heavy phase 242 is pressed radially outwards, and is pumped out through a stationary arranged centripetal pump 217 (also not shown in FIG. 2). To control the radial, horizontal distance between the centre of rotation of the bowl 210 and the interface 243 between the light 241 and the heavy 242 fractions, respective adjustable level rings 214, 215 are used in a per se conventional manner.

The centripetal pumps 216, 217 provide a certain overpressure of the phases 241 and 242 discharged from the outlets 212 and 213.

The separation plates 230 comprise through holes 231, preferably arranged opposite one another so that a substantially vertical through channel is formed through the stack. The through holes 231 are arranged at a relatively large radial distance from the bowl's centre of rotation which causes the light phase 241 which is fed out through the outlet 212 to be relatively pure, preferably purer than the heavy phase 242 which is discharged through the outlet 213.

To illustrate the difference between a centrifugal separator of purificator type and a centrifugal separator of concentrator type, which latter, in contrast to the separator of purificator type illustrated in FIG. 2, hence provides a separation in which the heavy phase is purified to a relatively greater degree than the light phase, a possible radial location L is illustrated, at a relatively small radial distance from the centre of rotation, for the holes 231, which position L would have been useful if the separator 200 had been of concentrator type.

Thus, the light phase will then, because of the use of the pump 216, be supplied at a certain overpressure at the outlet 212.

It will be appreciated that, in the present method, the light phase is essentially comprised of crude tall oil soap with some admixing of black liquor and washing fluid, while the heavy phase is comprised mainly of a mixture of, on the one hand, black liquor with a certain, very small, admixture of crude tall oil soap, and, on the other hand, washing liquid.

Furthermore, contaminants 250 are present in solid form, among other things fibre-containing sludge, in the mixture of black liquor and crude tall oil soap to be separated. These solid contaminants are separated out by a per se conventional ejecting device 251 which is arranged to intermittently separate out solid phase contaminants 250 accumulated in the separator 200 during operation, such as at regular intervals. The solid particles 250 may also comprise calcium compounds such as calcium carbonate.

FIG. 3 corresponds to FIG. 2, but shows a hermetic centrifugal separator 300 of purificator type. The separator 300 comprises, as is the case with separator 200, a stack of separating discs 330 with holes 331 forming a substantially vertical through channel through the stack 330. The mixture is supplied via an inlet 311 provided through a rotating shaft 320, which, in a way similar to the separator 200, is driven with at least 1000 RPM, preferably at least 3000 RPM, preferably about 5000 RPM, and hence also rotation drives the bowl 310 with this RPM.

The radial, horizontal distance from the centre of rotation of the bowl 310 for an interface 343 between the separated light phase 341 and the separated heavy phase 342 is regulated by controlling the various counter-pressures on the output phases, which is achieved using an overpressure by means of which the mixture is supplied to the inlet 311. Via an outlet 312, the light phase, with some impurities in the form of the heavy phase, is supplied; via an outlet 313, the heavy phase, with some impurities in the form of the light phase, is delivered. It is possible to use a pump wheel, rotating in the same direction, in the outlets for both or any of said phases, which results in that it becomes possible to achieve a selectable pressure of the respective outflowing phase. However, it is preferred not to use such a downstream-arranged pump, especially not for the heavy phase, since an elevated pressure is desirable upstream of the separator in order to achieve a sufficient pressure for pressing out the light phase. Since the holes 331 are disposed relatively far from the rotational centre, the light phase 341 delivered via the outlet 312 will, in a manner corresponding to that described above for the separator 200, be relatively pure, preferably purer than the heavy phase 342 which is delivered via outlet 313.

One difference between the separators 200 and 300 is that the phases 341, 342 which are supplied from the outlets 312, 313 can have a greater overpressure at the outlets 312, 313 than what is the case for the phases 241, 242 being delivered from the outlets 212, 213, since the mixture is already present at an overpressure via the inlet 311. In order to accomplish this overpressure, an as such conventional pump can be used. Additionally, a greater counter-pressure can be applied to the heavy phase 342 than what is possible for the heavy phase 242, since a too great counter-pressure on the phase 242 risks resulting in leakage from phase 242 to the light phase 241 in the separator 200, or crowding out of the separator through the gap between the rotating body and the inlet manifold.

For all separators 200, 300 described herein, it is preferred that the radial distance from the centre of rotation to the boundary 243, 343 is regulated to be approximately within the holes 231, 331.

The distances between the separating discs 230, 330 is preferably maximum 3 mm, preferably between about 0.5 and 2 mm.

It is preferred that the centrifugal separator 130, in FIG. 1, comprises separating plates according to the above, which thus operate to separate a relatively heavier phase from a io relatively lighter phase, and operating at at least 1000 RPM, preferably at least 3000 RPM, preferably at least 5000 RPM. The same also applies to the separators in steps 150 and 170 (see below).

In the present system 100 and method for separating crude tall oil soap from black liquor, a washing liquid of one of two possible types is used.

According to a first alternative, the washing liquid is a residue liquid derived from a tall oil producing processing step 180. In the processing step 180, crude tall oil soap is treated with acid, such as sulfuric acid, to form tall oil. Such a process is in itself conventional and used for the production of tall oil from a raw material consisting of crude tall oil soap, by adding acid to the crude tall oil soap, whereby crude tall oil soap is converted to tall oil and acidic water (residual acid). It is preferred that the step 180 is arranged within the same facility as the other parts of the system 100.

After the conversion, an acidic solution remains, thus sometimes referred to as residual acid, and which hence consists of an acidic residual liquid phase, preferably an aqueous solution, from the processing step 180. This residual acid is pH-regulated in a step 181, to a basic pH value which preferably lies between 10 and 14, preferably between 11 and 12. Said pH-control can be performed, for example, by adding sodium hydroxide NaOH, or alternatively white liquor.

The pH-controlled residual acid, which now is basic, is herein denoted “residual liquid”, and is used according to the invention, in its pure form or in recycled form after a first use in washing step(s) (see below), to wash the crude tall oil soap from its contents of black liquor.

A second alternative according to the invention is to, as the washing liquid, use a water solution of the above mentioned ash derived from the recovery boiler 102, such as after extraction in the electrostatic precipitator 103 and dissolved in the tank 104. Preferably, the device 104 is a system for continuous dissolution of ash using water, in which gravimetric clarification is performed before the washing liquid is supplied to step 181. It is preferred io that the ash solution has a dry matter content (Swedish “ts”), of ash, of at least 8%, preferably 8% -23%, preferably 13%-17%, most preferably about 15%. A dry matter content of at least 8% means that substantially no tall oil soap is dissolved in the ash solution when the ash solution is used as a washing liquid. The pH of the ash solution is preferably regulated in the same way as for the residual liquid, such as using white liquor or NaOH, to a pH value of between 10 and 14, preferably between 11 and 12.

In the following, the term “washing liquid” is used to refer to either residual liquid or ash solution according to the above. In some cases, it is also conceivable to as “washing liquid” use mixtures of residual liquid and ash solution in different proportions.

Herein, that the crude tall oil soap is “washed” means that it is mixed with a washing agent (as said washing liquid), whereupon crude tall oil soap is separated out from the mixture, which provides a washed fraction containing a smaller proportion of black liquor than was the case with the fraction before the washing step. Hence, according to the invention black liquor-containing crude tall oil soap is mixed with said washing liquid, whereupon crude tall oil soap is separated out from the resulting mixture.

A washing liquid which has been used as washing liquid in one (or several) previous washing step(s) also constitutes washing liquid in the terminology of the invention, although it may comprise major or minor proportions of contaminating black liquor from said previous washing step(s).

First, a first coarse separation 120, 130 of crude tall oil soap, from the contaminating black liquor contained in the crude tall oil soap, is performed, as described above, so that a first fraction of crude tall oil soap is formed.

This first crude tall oil soap fraction is supplied to a first mixing device 140, in which the first fraction of crude tall oil soap is mixed with washing liquid so that a first diluted fraction is formed.

io The first diluted fraction is brought to a first centrifugal separating step 150, comprising a centrifugal separator arranged to perform a separation of the first diluted fraction so that a second crude tall oil soap fraction is achieved. The second crude tall oil soap fraction contains a smaller content of black liquor than the first fraction of crude tall oil soap, and is thus purified relative to the first crude tall oil soap fraction.

In a preferred embodiment, the first centrifugal separator is of hermetically closed type, preferably of the type illustrated in FIG. 3 and described above. As a result, a sufficiently high input pressure may be used for the first diluted fraction, so that a very good separation can be achieved of the light fraction (i.e. crude tall oil soap with small contaminant amounts of black liquor and washing liquid), and the heavy fraction (i.e. the washing liquid with contaminants of black liquor and only small contaminant amounts of crude tall oil soap). It is preferred that the input pressure of the centrifugal separator 150 and/or 170 is an over-pressure of at least 5 bars, preferably 10 bars. This pressure can be accomplished in a known manner, such as by a pump arranged upstream of the respective centrifugal separator 150, 170.

The present inventors have surprisingly discovered that it is possible to use a washing with the help of such a centrifugal separator 150 to achieve very good purification results for the crude tall oil soap, when the pH-regulated residual acid from step 180 is used, alternatively pH-regulated ash solution from step 104. This purification process is also much easier and faster than the one described in U.S. Pat. No. 8,419,897 B2.

The separated, black liquor-containing heavy phase is brought to a subsequent processing step, which for example may be the evaporation step 101. An ejecting device 151, installed in step 150, for solid particles, captures fibre-containing slurry and other solids, and brings the like to the recovery boiler 102, more particularly it is mixed with the liquor which is fed to the recovery boiler 102.

According to a particularly preferred embodiment, illustrated in FIG. 1 and providing especially good results, the second crude tall oil soap fraction is brought to a second mixing io device 160, where it is mixed with the washing liquid so that a second diluted fraction is formed. Then, this second diluted fraction is brought to a second centrifugal separating step 170, which may be similar to the step 150, and which is arranged to perform a separation of the second diluted fraction, using a second centrifugal separator, which, like step 150, preferably is of hermetically closed type, so that a third crude tall oil soap fraction is achieved. This third crude tall oil soap fraction contains smaller contents of black liquor than the second fraction of crude tall oil soap, and is therefore relatively pure, preferably purer than the second crude tall oil soap fraction.

Using two centrifugal separators 150, 170, connected in series and preferably being of hermetically closed type, a crude tall oil soap with only very small quantities of contaminating black liquor be accomplished, at relatively little cost and low requirements on installation surface area. In addition, the cleaning process only requires a short period of time.

The preferred overpressure for the second centrifugal separator 170, in case this is used, is propagated from an over-pressurized outlet of step 150, or is alternatively achieved by means of a further, in itself conventional, pump between step 150 and step 170.

An ejection device 171 is arranged to capture solid particles, such as fibre-containing sludge, and bring this to the step 102.

The separated third crude tall oil soap fraction is brought to the acid treatment step 180, in which the crude tall oil soap is treated with acid as described above, to provide tall oil, which tall oil is then supplied to a step 105, such as a further processing step such as distillation to additional tall oil-based substances, or a use step for tall oil as a raw material in various processes. Step 105 may be arranged at another location. Apart from the step 105, it is preferable that all parts illustrated in FIG. 1 are locally arranged parts of one and the same local facility. In particular, it is preferred that the ash in the ash solution, if this is used as washing liquid, consists of ash derived from the recovery boiler 102 which is part of the same system 100 to which the purification steps 150, 170 belong.

The used residual acid is pH-regulated, in step 181, to be basic, and is recirculated to the mixing step 160. In case the ash solution from step 104 is used as washing liquid, the ash solution is pH-regulated correspondingly, to be basic, in step 104. It is appreciated that the step 181 is therefore either connected only to the step 180, only to the step 104 or, if a mixture of residual liquid and ash solution is used, or if it is desired to be able to select a type of washing liquid, to both step 180 and step 104. If ash solution is used as washing liquid only, the residual liquid from the step 180 can instead be supplied to the evaporation device 101, or to any step upstream thereof.

According to a particularly effective embodiment, as illustrated in FIG. 1, the washing liquid is brought in a counter-current circuit in relation to the crude tall oil soap. Thus, in this embodiment, the washing liquid supplied to the mixing device 140 consists of washing liquid which, in a first step, has been separated from the second crude tall oil soap fraction in step 170. In other words, the outlet for the heavy fraction of step 170 is connected to one of the inlets of the mixing device 140. This way, the washing liquid from step 181 can first be used once in the second separating step 170, and there absorb a certain percentage black liquor separated from the second diluted fraction, and then be reused in the first separating step 150, by therein absorbing larger proportions of black liquor from the first diluted mixture. Because the available volume of residual acid from the same facility for crude tall oil separation and -management, or the available amount of ash from the recovery boiler 102, is limited, this solution offers an extremely efficient use of the available washing liquid, which simultaneously provides very good results in terms of a final crude tall oil soap product with only low proportions of black liquor. In case ash solution is used as washing liquid, it is also achieved that the washed crude tall oil soap contains smaller amounts of precipitated lignin, since the ash solution, unlike the residual acid, contains no such precipitated lignin. On the whole, the invention accomplishes that two different system-internal residual products can be used, depending on availability and desires, to produce a final product of high quality.

In case the centrifugal separator 170 is not used, washing liquid is brought directly from step 181 to step 140.

Furthermore, according to the invention, the first centrifugal separator 150, and preferably also the second centrifugal separator 170, are of purificator type. This achieves a very good cleaning, especially when two such series-connected centrifugal separators 150, 170 of purificator type are used together in the manner described above.

As described above in connection to the ejector devices 131, 151, 171, it is preferred that at least the first centrifugal separator 131, and preferably all centrifugal separators 131, 151, 171 that are used to provide a respective crude tall oil soap fraction (such as the above mentioned first and second crude tall oil soap fractions, produced by the separators 150, 170), also achieve a separation of a respective fraction containing solid materials comprising fibres and possibly also precipitated salts, which solids-containing fraction is separated out and removed for further processing, such as in step 102.

It is particularly preferred that at least steps 140 and 150, but preferably also steps 160, 170, as well as preferably step 130 and also step 120, are performed continuously. Herein, the term “continuously” implies that the different steps 120, 130, 140, 150, 160 and 170 maintain a continuous stream of in- and outflowing fractions, as opposed to being operated intermittently or batch-wise. It is understood that interruptions for maintenance, cleaning and so on can occur, but that the main operation is preferably carried out continuously. Further, present equalization tanks (not shown in FIG. 1) and similar can be used between the continuously operated steps 130, 140, 150, 160, 170. It is preferred that the total throughput time for the separated crude tall oil soap arriving at the mixing step 140, until the washed crude tall oil soap arrives at step 180, is maximally 60 minutes, more preferably maximally 30 minutes, more preferably maximally 10 minutes.

In particular, according to this embodiment, a continuously supplied stream of the first crude tall oil soap fraction is achieved, which is continuously mixed with the washing liquid in the first mixing device 140, and separated in the first centrifugal separating step 150 so as to result in the second crude tall oil soap fraction. Furthermore, the second mixed crude tall oil soap fraction is mixed, in a continuously supplied stream, with the washing liquid in the mixing device 160, and is separated in the second centrifugal separating step 170 so as to result in the third crude tall oil soap fraction.

As the method is run continuously rather than in a batch-wise manner, the total capacity can be caused to be sufficiently high, using only relatively small, continuously operated devices.

According to a preferred embodiment, only the pH-regulated washing liquid is used to wash the crude tall oil soap during continuous operation, while, during an initial stage of the method, an aqueous sodium sulphate solution is instead supplied to the first mixing device 140, in place of the washing liquid, and possibly also to the second mixing device 160, instead of washing liquid. It will be appreciated that, in the above-described counter-current circuit for the washing liquid, said aqueous solution of sodium sulphate during the initial stage may be supplied only to the second mixing device 160 in place of the washing liquid, and that the separated heavy phase from the second separating step 170, which then contains such an aqueous sodium sulphate solution contaminated by black liquor, may be added to the first mixing device 140. It is also possible, in such an initial stage, to use, instead of the aqueous sodium sulphate solution, an ash solution as the one described above. This works as follows. In case the ash solution is used as washing liquid, the ash solution in question can simply continue to be used even after the initial stage. In case pH-regulated residual acid is used as washing liquid, after the initial stage, the choice of washing liquid can be changed from ash solution to residual acid.

In a preferred embodiment, substantially the entire volume of washing liquid supplied to the mixing devices 140, 160 originates either from the tall oil producing processing step 180 or from the recovery boiler 102 and via steps 103 and 104, following a pH adjustment in step 181, and substantially all of the resulting crude tall oil soap fraction, from the most downstream arranged separation step 170, is brought to the tall oil producing processing step 180 for further processing. Using the present system and method, it is possible to provide a very good purification of the crude tall oil soap while being restricted only to the washing liquid which is produced by the cleavage of the purified crude tall oil soap to tall oil, or alternatively to the one being available from the ash from the recovery boiler 102.

It is preferred that each series-connected separating step 150, 170 removes at least 70 percent by weight, preferably at least 80 percent by weight, of the black liquor contained in the respective diluted mixture.

Both steps 150 and 170 may comprise a respective single, or several parallel-connected, centrifugal separators, wherein all preferably are of hermetically closed type. It is preferred that the total capacity of each centrifugal separator in these steps 150, 170, preferably the total capacity in the respective steps 150, 170, is maximally 70 m³/h.

In one example, black liquor from the cooking step 110 of a pulp fabrication process according to the Kraft method, was treated in an initial coarse separation step, in turn comprising a gravity separation tank 120 and a thickening system comprising several series-connected tanks 135, resulting in a first fraction of 1000 l crude tall oil soap, containing 100 l of free fluid and 900 l of black liquor-mixed crude tall oil soap. The free liquid consisted mainly of black liquor, and the black liquor-mixed crude tall oil soap consisted of “solid” crude tall oil soap with a certain “enclosed” content of 35% black liquor.

Hence, the 1000 l of crude tall oil soap contained a total of 415 l of black liquor, both in “free” form and in a form “contained” in the crude tall oil soap. The black liquor contained in the 1000 l of crude tall oil soap, in turn, comprised a certain share solid material, in the form of fibre-containing slurry.

The 1000 l of crude tall oil soap were treated by a system 100 such as the one illustrated in FIG. 1, in which two series-connected centrifugal separators 150, 170 washed the crude tall oil soap using a counter-flowed washing liquid in the form of basic-made residual acid from the step 180. After an aqueous solution of sodium sulphate, in an initial stage, was supplied to the second mixing device 160, the said washing liquid was instead brought to the second mixing device 160, once the continuously operating process had been allowed to start. A total of 1500 l basic-made residual acid was used.

Once all crude tall oil soap had been purified, about 94.1% of the total black liquor contained in the crude tall oil soap had been removed, together with the corresponding share of the solid particles contained in the crude tall oil soap.

The final result for a corresponding experiment, in which only one centrifugal step 150 was used, was about 78.3% removal of black liquor.

During a subsequent tall oil producing step 180, tall oil was then produced from the purified tall oil soap, by treatment with sulfuric acid. Thereafter, the obtained tall oil was purified in an additional centrifugal separation step, which among other things removed fibre-containing slurry as solid particles, which were removed by ejection from the centrifuge in question. The ejected volume was 28 l.

The corresponding tests with ash solution from the step 104 yield similar results.

In case a conventional method had been used instead, in which the crude tall oil soap had been separated only using gravimetric separation, the tall oil would comprise totally about 560 l fibre-containing slurry, which would then have to be removed using such ejection. At the used crude tall oils soap flow of 10 000 l/h crude tall oil soap, ejection would have been required every third minute during continuous operation. In the example of a centrifugal separation step 150 according to the invention, however, only a total of 121 l fibre-containing slurry was found, which resulted in that ejection only must had to be performed about every thirteen minutes during continuous operation. In the example according to the invention, with two centrifugal separation steps 150, 170, a total of 33 l fibre-containing slurry was found, and ejection was necessary only about each fifty minutes.

To be able to perform ejection of slurry less frequently means considerable gain in the form of prolonged useful life for the tall oil purification centrifuge, and also the possibility to increase capacity for the tall oil plant, since the slurry ejection frequency is a limiting factor.

Moreover, lesser amounts of harmful hydrogen sulfide are formed during the acidification of the crude tall oil soap in the cleavage plant for tall oil production, the more black liquor that is washed away before this step.

Above, preferred embodiments have been described. However, numerous modifications can be made of these embodiments without departing from the basic idea of the invention.

For example, additional initial coarse separations can be performed, apart from the described ones 120, 130.

The outlet from step 150 for the separated heavy fraction (black liquor) can also, instead of being brought to the recovery boiler 102, be returned to step 120, for recapture of any crude tall oil soap lost in the separating step 150.

Furthermore, other types of separators than the ones illustrated in FIGS. 2-3 can be used. However, it is preferred not to use any separators of so called basket centrifuge type.

In FIG. 1, two series-connected first and second centrifugal separating steps 150 and 170 are illustrated, after the first coarse separating step 120, 130, 135. It is, however, also possible to arrange more than two series-connected centrifugal separating steps, such as three, four or more. In this case, such steps are connected in series, according to the above described in connection to steps 150, 170, preferably using a counter-flow connected washing liquid.

Residual products from the step 180 can be recirculated to the step 120, alternatively to the step 101.

Hence, the invention is not limited to the above described embodiments, but can be varied within the scope of the enclosed claims.

1. Method for purifying crude tall oil soap from black liquor, wherein a washing liquid is used, which washing liquid is either derived from a tall oil producing processing step in which crude tall oil soap is treated with acid to form tall oil, wherein the washing liquid is an acidic residual liquid phase from this processing step that has been pH-regulated, or alternatively that the washing liquid is a pH-regulated aqueous solution of ash, or alternatively that the washing liquid is a mixture of such washing liquids, wherein black liquor-containing crude tall oil soap is mixed with said washing liquid, and wherein the crude tall oil soap is then separated out from the resulting mixture, wherein the method comprises the steps of
a) performing a first coarse separation of crude tall oil soap from said black liquor, so that a first crude tall oil soap fraction is formed;
b) mixing the first crude tall oil soap fraction with washing liquid, so that a first diluted fraction is formed; and
c) performing a separation of the first diluted fraction using a first centrifugal separator of purificator type, so that a second crude tall oil soap fraction is achieved,
wherein whereby the second crude tall oil soap fraction comprises smaller contents of black liquor than the first crude tall oil soap fraction.

2. Method according to claim 1, wherein the method further comprises the additional steps of
d) mixing the second crude tall oil soap fraction with washing liquid of the said type, so that a second diluted fraction is formed; and
e) performing a separation of the second diluted fraction, using a centrifugal separator of purificator type, so that a third crude tall oil soap fraction is achieved,
wherein the third crude tall oil soap fraction comprises smaller contents of black liquor than the second crude tall oil soap fraction.

3. Method according to claim 2, wherein the washing liquid which is supplied in step b) is a washing liquid of the said type which has been separated out from the second crude tall oil soap fraction in step e).

4. Method according to claim 1, wherein the washing liquid of the said type at least to a part is constituted by ash from a recovery boiler (102), which ash has been dissolved in water and pH-regulated.

5. Method according to claim 4, wherein the washing liquid has a dry matter content of at least 8%, more preferably between 8-22%, even more preferably between 13-17%, most preferably about 15%.

6. Method according to claim 1, wherein the first, and in applicable cases also the second centrifugal separator, comprises respective stacks of separating discs with through holes, which discs are operable for separating a relatively heavier phase from a relatively lighter phase, and wherein both centrifugal separators are operated at at least 1000 RPM.

7. Method according to claim 1, wherein the first, and in applicable cases also the second, centrifugal separator is of hermetically closed type.

8. Method according to claim 1, wherein the first coarse separation comprises a separation of a crude tall oil soap fraction using a centrifugal separator comprising stacks of separating discs comprising through holes, which discs are operable to separate a relatively heavier phase from a relatively lighter phase, which centrifugal separator operates at at least 1000 RPM.

9. Method according to claim 1, wherein steps b) and c), and in applicable cases also steps d) and e), are performed continuously, so that a continuously supplied stream of the first crude tall oil soap fraction from the step a) is continuously mixed with the washing liquid in the step b) and separated in step c) so as to result in the second crude tall oil soap fraction, and in applicable cases so that the second crude tall oil soap fraction is mixed in a continuously supplied stream with the washing liquid in step d) and separated in step e) so as to result in the third crude tall oil soap fraction.

10. Method according to claim 1, wherein an aqueous solution of sodium sulphate is used in step b), and in applicable cases also in step d), instead of washing liquid, during an initial stage of the method.

11. Method according to claim 1, wherein the washing liquid of the said type, which is supplied in step b), and in applicable cases also in step d), has a pH value of 10-14, preferably about 11-12.

12. Method according to claim 1, wherein substantially the whole volume of washing liquid which is supplied originates from the said tall oil producing processing step, alternatively comprises dissolved ash which in its entirety originates from a recovery boiler, and wherein substantially the whole resulting crude tall oil soap fraction is brought to the tall oil producing processing step for further treatment.

13. System for purifying crude tall oil soap from black liquor, wherein a washing liquid is used, which washing liquid is either derived from a tall oil producing processing step in which crude tall oil soap is treated with acid to form tall oil, wherein the residual liquid is an acidic residual liquid phase from this processing step that has been pH-regulated, or alternatively that the washing liquid is a pH-regulated aqueous solution of ash, or alternatively that the washing liquid is a mixture of such washing liquids, wherein the system is arranged to mix black liquor-containing crude tall oil soap with said washing liquid, and to thereafter separate out the crude tall oil soap from the resulting mixture, wherein system comprises
a) a first coarse separating step, arranged to separate out crude tall oil soap from said black liquor, so that a first crude tall oil soap fraction is formed;
b) a first mixing step, arranged to mix the first crude tall oil soap fraction with washing liquid of said type, so that a first diluted fraction is formed; and
c) a first separating step, comprising a first centrifugal separator of purificator type, which separating step is arranged to separate out the first diluted fraction, using the first centrifugal separator, so that a second crude tall oil soap fraction is achieved,
wherein the system is arranged to that the second crude tall oil soap fraction comprises smaller contents of black liquor than the first crude tall oil soap fraction.

14. System according to claim 13, wherein the system further comprises
d) a second mixing step arranged to mix the second crude tall oil soap fraction with washing liquid of the said type, so that a second diluted fraction is formed; and
e) a second separating step comprising a centrifugal separator of purificator type, arranged to separate the second diluted fraction so that a third crude tall oil soap fraction is achieved,
wherein the system is arranged so that the third crude tall oil soap fraction comprises smaller contents of black liquor than the second crude tall oil soap fraction.

15. System according to claim 14, wherein the washing liquid which is supplied in step b) is a washing liquid of the said type which has been separated out from the second crude tall oil soap fraction.
